(19) United States
(12) Patent Application Publication
(10) Pub. No.: US 2026/0333119 A1
(43) Pub. Date: Oct. 22, 2026

(54) DELAY STATUS REPORT FOR EXTENDED REALITY (XR) WIRELESS COMMUNICATIONS

(71) Applicant: Google LLC, Mountain View, CA (US)

(72) Inventor: Shiangrung Ye, Taipei (TW)

(21) Appl. No.: 19/100,503

(22) PCT Filed: Aug. 2, 2023
(86) PCT No.: PCT/US2023/029323

§ 371 Date: Jan. 31, 2025

Related U.S. Application Data
(60) Provisional application No. 63/370,466, filed on Aug. 4, 2022.

(51) Int. Cl. H04W 28/02; H04W 76/15

(52) U.S. Cl. CPC H04W 28/0278; H04W 76/15

(57) ABSTRACT

Methods and systems are disclosed herein for transmitting a delay status report (DSR) between a user equipment (UE) device (105) and a network entity (112), for optimizing resource allocation. For example, a UE device receives a message from a network entity configuring the UE device with one or more channels and delay threshold(s) associated therewith. The UE device monitors a first data arriving in the uplink buffer for one or more channels configured by the message. When the UE device determines that a delay of the first data in the uplink buffer for the one or more channels has reached at least one of the delay thresholds, the UE device generates a DSR. The UE device transmits the DSR to the network entity when a triggering condition associated with the DSR is satisfied. The network entity may then reallocate resources to reduce the data delay status in the UE device.

### CROSS-REFERENCE TO RELATED APPLICATION

This application claims, in accordance with Article 8 of the Patent Cooperation Treaty (PCT), the priority and benefits to the U.S. Provisional Application No. 63/370,466, entitled “DELAY STATUS REPORT FOR EXTENDED REALITY (XR) WIRELESS COMMUNICATIONS,” and filed Aug. 4, 2022, which is expressly incorporated by reference herein in its entirety.

### TECHNICAL FIELD

The present disclosure relates generally to wireless communication, and more particularly, to systems and methods of reporting delay status.

### BACKGROUND

The Third Generation Partnership Project (3GPP) is currently in the process of specifying updates to a Radio Interface called 5G New Radio (5G NR) as well as a Next Generation Packet Core Network (NG-CN or NGC). The 5G NR architecture has three main sections: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

Extended reality (XR) includes various augmented reality, virtual reality, and mixed reality applications that take advantage of 5G NR network capabilities (e.g., ultra-low latency, high data transfer rate, etc.). Because XR expects low latency and high data rates, there are opportunities to support more efficient resource allocation in a 5G RAN.

### SUMMARY

The present disclosure provides methods and techniques for generating and transmitting a delay status report between a user equipment (UE) device and a network entity, such as to improve resource allocation. The disclosed techniques may enable communications that satisfy various requirements in extended reality (XR) applications. XR and cloud gaming (CG) may refer to various types of augmented, virtual, and mixed environments, in which users may use multiple devices to interface and interact with a computer generated environment in real time (or with minimal delay given hardware limitations). As such, a user may sense input and/or feedback delay if data transmission is delayed (e.g., when insufficient resources are allocated in a particular input/output device).

XR communications require various capacity improvements over existing telecommunication capabilities. For example, XR services are characterized by more stringent requirements for periodicity, multiple flows, synchronized flows, jitter avoidance, low latency, high reliability, among others. For evaluation of XR/CG applications, the system capacity is defined as the maximum number of users per cell satisfying a certain set of requirements. Although the certain set of requirements for XR/CG is still under discussion, they seem to encompass a certain percentage (e.g., 90% or 95%) of UEs fulfilling a threshold Packet Delay Budget (PDB) or a threshold Packet Error Rate (PER).

As a consequence of this approach to defining system capacity, the more the UE devices of users have their XR service communications requirements satisfied, the higher the capacity of the service cell. Because each UE may fall in different operating situations, a network entity may improve its calculated network capacity for XR applications by allocating resources to increase the number of users per cell that satisfy the XR service communication requirements. Each user may have one or more UE devices. In XR contexts, a user is satisfied when all UE devices involved in an XR application are satisfied-for example, a user is not satisfied if one of multiple UE devices is out of sync or substantially delayed even if other UE devices are satisfied in terms of PDB or PER requirements. The UE devices may provide individual and/or group identifiers (IDs) to signal they belong to the same user or XR application session.

In New Radio (NR), buffer status reports may inform a network entity about a UE device's uplink buffer size level. The network entity, however, does not know when data arrived at the UE device's uplink buffer. At best, the network might make some assumptions regarding a time of data arrival to the buffer based on First-In First-Out (FIFO) and fluctuating buffer size level premises. Thus, the network entity has difficulties optimizing resource allocations to minimize the delay of pending uplink data stored in the buffer. The present disclosure addresses these issues by configuring the UE devices to generate and transmit a delay status report to the network entity, which may then support the network to allocate resources to maximize network capacity for XR and other applications.

According to aspects of the present disclosure, for example, a UE device monitors data having queueing delay greater than a delay threshold. The UE device dynamically or periodically transmits a delay status report to the network entity. The delay status report includes the volume of the delayed data and satisfaction level for a channel or a group of channels. For example, a UE device may be declared as a satisfied UE device when the data streams of concern meet the respective packet error rate (PER) and packet delay budget (PDB) (or threshold) requirements. Based on the delay status report information, the network entity then determines resource allocation updates, if needed, to improve the network capability.

According to aspects of the present disclosure, a UE device receives a message from a network entity configuring the UE device with one or more channels and delay threshold(s) associated with the one or more channels. The UE device monitors a first data arriving in the uplink buffer for one or more channels configured by the message. When the UE device determines that a delay of the first data in the uplink buffer for the one or more channels has reached at least one of the delay thresholds, the UE device generates a delay status report (DSR). The UE device may separately transmit the DSR to the network entity when a triggering condition associated with the DSR is satisfied. There may be various triggering conditions, depending on the configuration specified in the configuration message.

For example, one triggering condition may involve a first timer. The UE device starts the first timer upon the first data arriving in the uplink buffer for the one or more channels. The triggering condition is satisfied when the first timer expires before the UE device has removed the first data from the buffer (e.g., in response to a completed or successful transmission of the first data). In other words, the expiration of the first timer initiates both the DSR generation and the DSR transmission. In addition, the triggering condition may further accommodate one or more channels configured by the network entity as having a higher priority than other channels.

One triggering condition may involve receiving new data arriving in the uplink buffer for the one or more channels. For example, the triggering condition associated with the DSR may include receiving new data when there are existing delayed data in the uplink buffer. In another example, the triggering condition may include receiving new data when the delayed data (e.g., a sum of various data in the buffer) in the uplink buffer has exceeded a delay volume threshold. In yet another example, the triggering condition associated with the DSR may further include at least one of: a volume of a delayed portion of the first data exceeding a volume threshold defined in the at least one of the delay thresholds; or a volume of buffered first data exceeding a threshold criterion.

Another triggering condition may involve a second timer. For example, the UE device may start a second timer upon transmitting the DSR to the network entity. The UE device generates and transmits a second DSR upon an expiration of the second timer (e.g., the expiration of the second timer being the triggering condition for generating and transmitting the second DSR). The UE device may stop the second timer when (a) the UE device does not have delayed data in a memory buffer, (b) a volume of delayed data has become smaller than a volume threshold defined in the at least one of the delay thresholds, (c) a media access control (MAC) is reset, or (d) the UE device receives, from the network entity, a request to stop the second timer.

One triggering condition may involve a command by the network entity. For example, the UE device generates and transmit the DSR responsive to receiving the command. The command may include one or more of a media access control (MAC) control element (MAC CE); an identifier (ID) of a channel corresponding to the DSR; a delay timing threshold; or a delay volume threshold. In some cases, the first timer and the second timer are configured by the message that the network entity has sent to configure the UE device. As further discussed below, a network may implement other triggering conditions to improve wireless resource utilization based on received DSRs.

According to aspects of the present disclosure, the DSR may include useful information for the network entity to determine an appropriate wireless resource allocation update. For example, the DSR may include one or more identifiers (IDs) for the one or more channels. The DSR may further include buffer size information for the delay thresholds associated with the one or more channels. The DSR may include a target level of resource allocation satisfaction for XR communications. The DSR may also include a maximal level of delay permissible in the UE based on a memory buffer size, a tier of delay time periods, a tier of delay volumes, or combination. Based on the DSR information, the network entity may reallocate wireless resources from one UE device to another UE device that experiences unsatisfactory transmissions (e.g., delays exceeding thresholds).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for a user equipment (UE) device 105 reporting delay status to a radio access network (RAN) 112, according to some embodiments;

FIG. 2 is a signaling diagram depicting an example method of reporting delay status from the UE device 105 to the network entity 112, according to some embodiments.

FIG. 3 is a signaling diagram depicting an example method of reporting delay status from the UE device 105 to the RAN 112, according to some embodiments;

FIG. 4 illustrates example timers associated with reporting delay status by a UE, according to some embodiments;

FIG. 5 illustrates example events associated with delayed data for reporting delay status, according to some embodiments;

FIG. 6 is a flow diagram depicting a method for reporting delay status by a UE device, according to some embodiments;

FIG. 7 is a flow diagram depicting a method for resource allocation by a network entity, according to some embodiments; and

FIG. 8 is a block diagram depicting an example device diagram of a UE device or a communication device, according to some embodiments.

FIG. 9 illustrates various examples of triggering conditions, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can apply to any network environment.

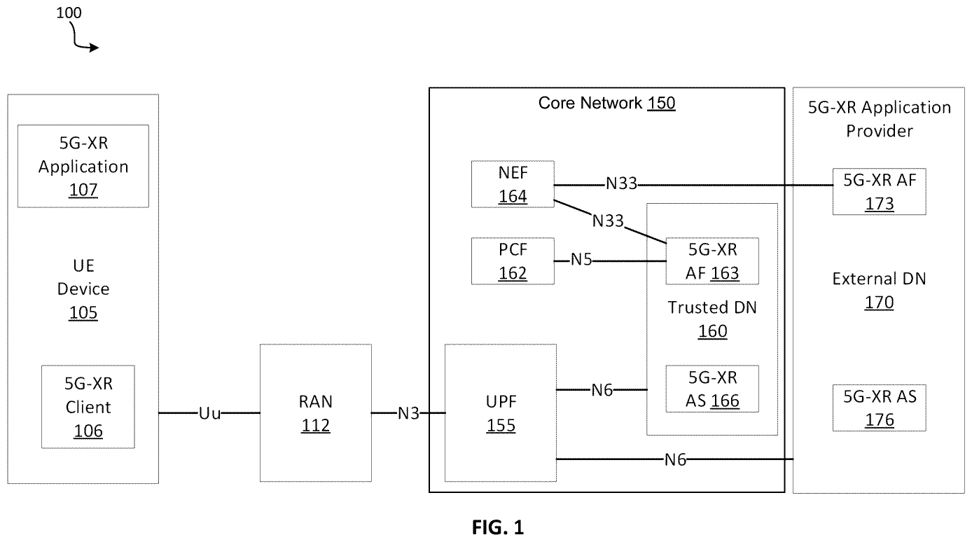

FIG. 1 is a block diagram depicting an example environment 100 for a user equipment (UE) device 105 reporting delay status to a radio access network (RAN) 112, according to some embodiments. The example environment 100 illustrates an example system architecture of a 5G system capable of delivering data for extended reality (XR) applications. As shown, relevant functions of the 5G system are illustrated, including the UE device 105, the RAN 112, and the core network (CN) 150. The CN 150 includes the user plane function (UPF) 155, the trusted data network (DN) 160, the policy control function (PCF) 162, and the network exposure function (NEF) 164. XR specific functions or components may include the 5G-XR client 106 of the UE device 105, the application function (AF) 163 and the application server (AS) 166 in the trusted DN 160, as well as the AF 173 and AS 176 in the external DN 170, which provides various XR applications. The external DN 170 may be a 5G-XR application provider leveraging 5G system functionalities (e.g., coupled with the NEF 164 and UPF 155 of the 5G system). The UE device 105 including a 5G-XR aware application 107 may make use of the 5G-XR client 106 and network functions 150, using network interfaces and APIs.

XR may refer to human-machine interaction experiences with visual, audio, and/or haptic computer-generated object enhancement or replacement. For example, XR may be one or more of augmented reality (AR), mixed reality (MR), virtual reality (VR), and interpolations among these XR variations. AR refers to providing a user with additional information or artificial generated items or content overlaid upon the real surroundings. VR refers to a rendered version (e.g., generated by computers) of a visual/audio scene. MR refers to an advanced form of AR where some virtual elements are inserted into the physical scene with the intent to provide the illusion that the elements are part of the real scene. In some cases, AR, MR, and VR may generally be referred to as immersion, which often requires measurements of motions of the user (e.g., six degrees of freedom) and providing near-instant feedback (e.g., via visual, audio, and tactile components) to the user.

Computer technologies (e.g., 3D graphics and measurements) and wearable technologies (e.g., motion sensors, visual and audio feedback, etc.) are enablers of XR. For example, human-to-machine and human-to-human communications take advantages of handheld and wearable end user devices (e.g., UE devices). These technologies capture, generate, process, and communicate with a large amount of data, often in real time (or with stringent low latency requirement). As shown in FIG. 1, the 5G-XR application and the 5G-XR client of the UE device 105 may capture and communicate user data to the RAN 112.

Cloud gaming (CG) is an example use case of XR, because CG may take advantage of AR, MR, or VR. CG applications often offload a large amount of computations from various UE devices (e.g., VR headsets, cameras, motion sensors, smart phones, etc.) to edge or remote server(s). CG and other XR use cases are often characterized by quasi-periodic traffic (with possible jitter) and high downlink (DL) data rates (e.g., video steam) combined with frequent uplink (UL) signaling, (e.g., pose/control update and/or UL video stream). In order to achieve cognitive presence and perceptive presence, both DL and UL traffic may be characterized by relatively strict packet delay budget (PDB) or threshold criteria. However, the current discontinuous reception (DRX) configurations do not fit well for (i) non-integer XR traffic periodicity, (ii) variable XR data rate, and/or (iii) quasi-periodic XR periodicity. The present disclosure provides methods and techniques for satisfying these XR-driven requirements.

The set of anticipated XR and CG services exhibits a certain variety and set of characteristics for the data streams (e.g., video) and they may change “on-the-fly” or dynamically. Additional information on the running services from higher layers, e.g., the QoS flow association, frame-level QoS, ADU-based QoS, XR specific QoS, etc., may be beneficial to facilitate informed choices of radio parameters by the RAN 112. XR application awareness by UE devices and network entities may improve the user experience, improve the NR system capacity in supporting XR services, and reduce the UE power consumption (e.g., effective radio parameters increase energy efficiency and may improve battery life in many small-scale UE devices).

In evaluating XR capacity, a UE device 105 may be considered as a satisfied UE if the XR data streams meet the respective packet error rate (PER) and PDB requirements, such as more than a certain percentage of packets are successfully transmitted within a given air interface PDB. For example, in DL-only evaluation, only DL streams are considered when identifying UE satisfaction. In UL-only evaluation, only UL streams are considered when identifying UE satisfaction. Evaluating XR capacity on the system level involves calculating the maximum number of UE devices (or users when a user has multiple UE devices) per cell with at least a percentage of satisfied UEs among connected UEs. For example, the percentage may be 90% or 95%.

PDB may be used to specify or model the latency requirements of XR traffic in the RAN (e.g., the air interface). For example, the PDB is a limited time threshold for a packet to be transmitted over the air from the RAN 112 to the UE device 105. For a given packet, downlink delay incurred in the air interface may be measured from the time that the packet arrives at the RAN 112 to the time that it is successfully transferred to the UE device 105. When the delay is larger than a given PDB for the packet, the packet is considered to have violated PDB. The value of PDB may vary for different applications and traffic types. XR traffic may endeavor to conform to a packet success rate. For example, when a packet delivery delay exceeds a given PDB, system evaluation may consider the packet having failed in delivery. For example, for a DL stream, an expected packet success rate may be 99% (PER less than 1%).

As shown in the environment 100 of FIG. 1, communications between the UE device 105 and the RAN 112 aspects of the present disclosure seek to improve XR traffic flow to provide efficient resource allocation and scheduling for XR service characteristics (periodicity, multiple flows, jitter, latency, reliability, etc.). As mentioned previously, the XR capacity may be characterized in terms of the maximum number of users per cell with a target percentage of satisfied UE devices, and the RAN 112 can ascertain the conditions of unsatisfied UE devices to improve resource allocation efficiency. The present disclosure provides techniques for the RAN 112 to configure the UE device 105 to generate and transmit delay status reports to the RAN 112 when certain conditions are satisfied (e.g., the conditions preventing inefficient resource consumption).

In current practice in 5G NR, the RAN 112 may know the buffer size level of the UE device 105 via the buffer status report. The RAN 112 may not know when data arrives at UE's buffer and/or which UE device (among multiple UE devices including the UE device 105) may have more buffered data waiting in the buffer for an extended period of time. As a result, the RAN 112 might not efficiently allocate resources (e.g., bandwidths, channel priorities, etc.) to maximize network capacity for XR applications.

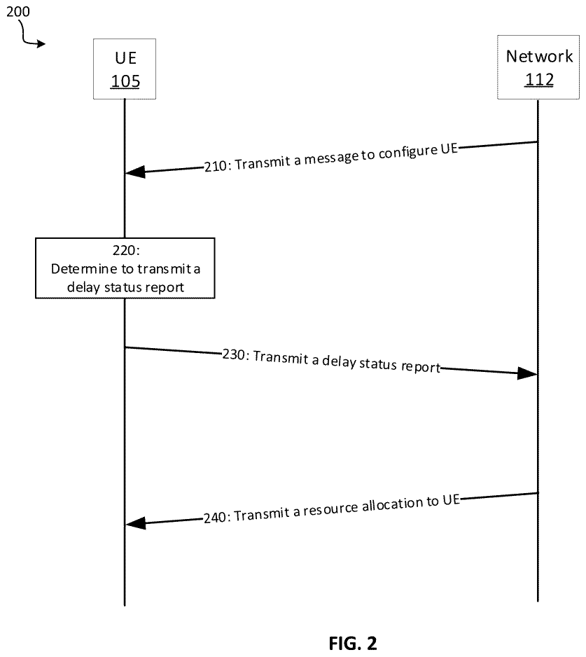

The present disclosure provides methods and techniques for overcoming such shortcomings by transmitting a delay status report from the UE device 105 to the RAN 112 (e.g., periodically, upon achieving a predefined trigger criterion, or upon network demand). For example, the delay status report includes information about the volume of the delayed data and satisfaction level for one or more channels. The RAN 112 may then, based on the delay status reports (e.g., from multiple UE devices), adjust or update resource allocations to maximize the XR capacity of the environment 100. Detailed examples are further discussed in relation to FIGS. 2-5 below.

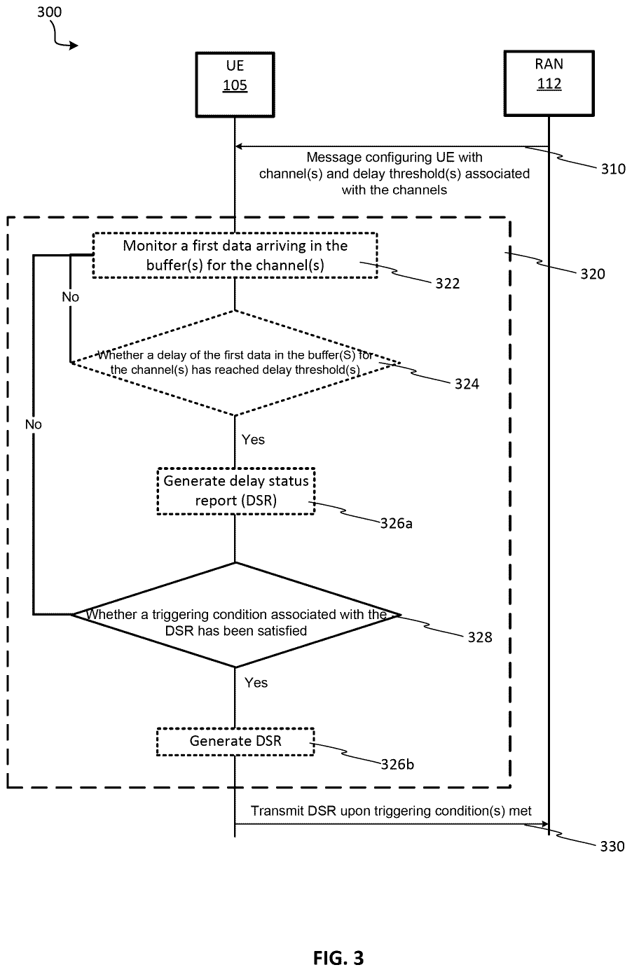

The UE device 105 can report the delay status to one or more entities in a network. For example, FIG. 2 demonstrates signaling diagram for a UE device 105 to report delay status to the network entity 112, while FIG. 3 demonstrates a method within the UE device 105 of reporting delay status to the RAN 112.

FIG. 2 is a signaling diagram 200 depicting an example method of reporting delay status from the UE device 105 to the network entity 112, according to some embodiments. The UE device 105 may correspond to the UE device 105 of FIG. 1. Likewise, the network entity 112 may correspond to the RAN 112. The signaling diagram 200 is not limited to a single instance of the UE device 105 or the network entity 112. In some cases, multiple UE devices may signal with the network entity 112, and the UE device 105 may signal with multiple network entities about reporting delay status for different radio bearers or logical channels.

Although FIG. 2 illustrates example operations between the UE device 105 and the RAN 112, in other implementations, different entities may perform similar or same operations. For example, in some embodiments, instead or in the place of the RAN 112, another UE device may perform similar operations via sidelink connections (e.g., via PC5 instead of Uu) with the UE device 105. That is, the other UE device may configure, via sidelink, the UE device 105 to transmit DSRs for updating sidelink resource allocations. In some embodiments, instead of or in the place of the UE device 105, another network entity (e.g., base station, such as a 4G LTE base station or the like) may monitor XR traffic in its buffers (downlink, uplink, or both) and transmit DSRs when one or more triggering conditions are satisfied. For example, one child base station may provide delayed status report to a parent base station in integrated access and backhaul (IAB) configurations. Other variations are possible without limitations by the examples of the UE device 105 and the RAN 112 discussed below.

As shown in FIG. 2, the network entity 112 transmits 210 a message to configure the UE device 105 regarding a delay status report procedure. For example, the network entity 112 transmits a first message to configure UE with a first channel. The first channel may be a radio bearer or a logical channel. The first message may include a first delay time threshold, a first delay volume threshold, or both, associated with the first channel. The first channel may refer to a set or a group of channels. For example, the network transmits the first message to configure the UE device 105 with a set or group of channels. There may be a time delay threshold or volume threshold associated with the channel group. Channels in the group may apply the same time delay threshold. The volume threshold may be applied on the channel group level (as well as for each individual channels, if so configured). When applied on the channel group level, the volume threshold may apply to the amount of data from the channel group.

The first message from the network entity 112 to the UE device 105 may be implemented in various forms. In an example, the first message may be a radio resource control (RRC) reconfiguration message. In another example, the first message may be an RRC setup message. In yet another example, the first message may be an RRC re-establishment message or an RRC resume message. In some examples, the first message may be a system information message.

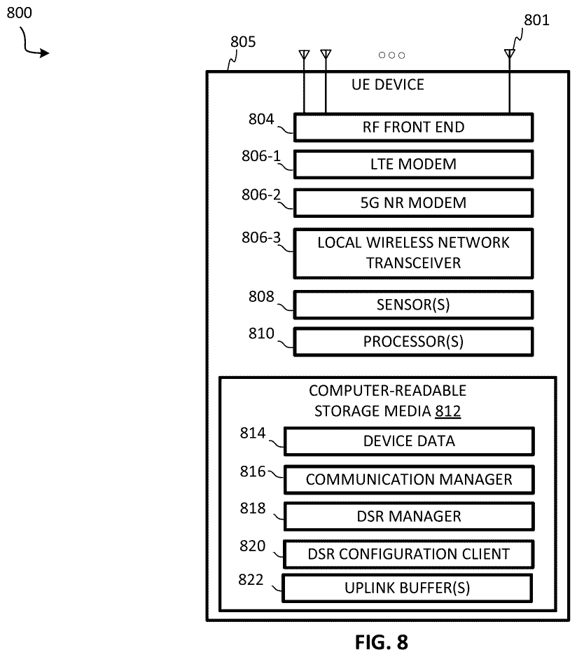

After receiving a delay status report configuration, the UE device 105 determines 220 to generate a delay status report by monitoring delay status of buffered data. For example, after a first data of the first channel arrives at the uplink buffer (shown in FIG. 8), the UE device 105 monitors whether the queueing delay of the first data is longer than a first time delay threshold. The UE device 105 achieves the monitoring by starting a first timer and associating the first timer with the first data. For example, when the first timer expires and the UE device 105 has not transmitted the first data from the buffer, the UE device 105 may consider the first data as delayed. In other words, the recorded status of the first data may be indicated as delayed in the UE device 105. As time progresses, when the first data is transmitted (which may include receiving a positive acknowledgement from the first data receiver), the UE device 105 may clear the first data from the uplink buffer and remove the delayed status of the first data.

In some cases, due to data segmentation, only a portion of the data may have completed transmission. In that case, the UE device 105 may not consider the segmented first data as delayed (and may consider the delay status on a segment-by-segment basis). For example, under packet data convergence protocol (PDCP), the UE device 105 may associate and start a timer for each arriving PDCP service data unit (SDU). If the timer expires and the PDCP SDU has not been transmitted to the network entity 112, the UE device 105 considers that the PDCP SDU is delayed. When the data is delayed, the UE device 105 may, in the delay status report (DSR), report the size (or sum of all delayed data) of the delayed data (and mark the delayed data) to the network entity 112. The UE device 105 may stop the first timer after the UE device 105 has transmitted the first data.

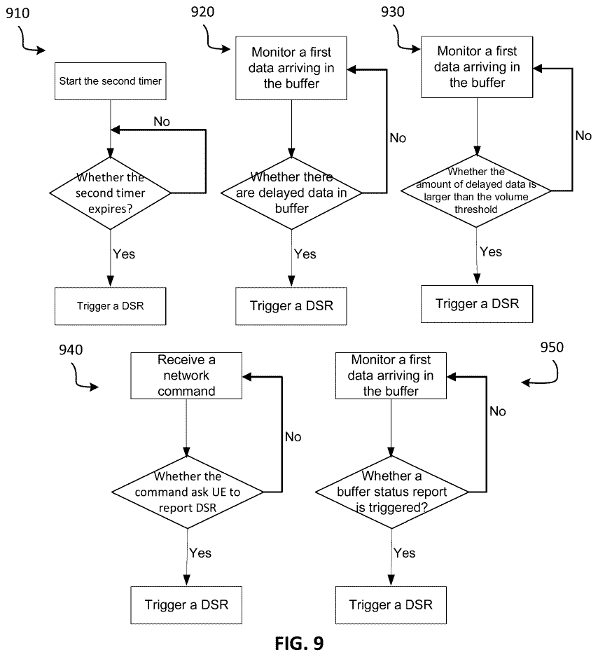

Upon being triggered the UE device 105 generates the delay status report 105 and transmits 230 the DSR to the network entity 112. The trigger depends on various conditions, which may be configured by the network entity 112. In some cases, the triggering conditions avoid wasting uplink resources when the DSR, though generated, may not be sufficient to inform the network entity 112 to update resource allocation. For example, a DSR may be generated due to time delay or excessive volume in a channel buffer of the UE device 105, but the corresponding channel may not have a sufficient priority level (as configured) for the DSR transmission. Various triggering conditions are further discussed below regarding FIGS. 3-5, and illustrated in FIG. 9.

The DSR includes various aspects of information. For example, the DSR includes an identifier (ID) for the associated channel or the set or group of channels. A bitmap may be used to associate each bit therein with a channel or a group of channels. In this example, if a bit is set, that implies the delay status information of the corresponding delayed data is included in the DSR. 105 The DSR may provide respective buffer size information of the delayed data. In some cases, the buffer size information may indicate an actual buffer size, or one or more buffer size ranges.

In some embodiments, the DSR may indicate a satisfaction level of the UE device 105. For example, the UE device 105 may calculate the percentage of delayed data and include the satisfaction level for the channel(s) in the DSR. In some embodiments, the DSR may indicate a maximum delay duration of the delayed data in the uplink buffer of the UE device 105. The maximum delay duration may include an actual delayed period or an indicator of a range covering the actual delayed period (e.g., the range may correspond to a level of urgency).

The UE device 105 may transmit 230 the DSR in various forms. For example, the UE device 105 may transmit the DSR in a medium access control control element (MAC CE), e.g., as DSR MAC CE. The DSR MAC CE may be associated with a unique ID (e.g. logical channel ID) to distinguish itself from other MAC CEs in a MAC protocol data unit (PDU). The UE device 105 may include other buffer-related status reports (e.g., as defined in 5G NR standard) in the DSR MAC CE. For example, for each channel, the UE device 105 may include a first buffer size information to indicate buffer size of both delayed and non-delayed data. The UE device 105 may also include a second buffer size information to indicate the buffer size of the delayed data. In some embodiments, the DSR MAC CE has a higher priority than data from other logical channels. For example, when assembling a MAC PDU, the UE device 105 may include the DSR MAC CE first in the MAC PDU. In some cases, the DSR MAC CE may include delay information (e.g., remaining time) associated with data volume information (e.g., data volume to be transmitted).

In some embodiments, the DSR MAC CE may have different formats. For example, the DSR MAC CE may have a short format, which is 5 or/to 8-bits in length. The DSR MAC CE may have a long format, which is 16 or/to 32 bytes long. Each format is identified by a unique ID such as different logical channel identifier. Depending on available space in a MAC PDU, the UE device 105 may choose one of the different formats and include the DSR in the MAC PDU. The UE device 105 may report a DSR for each channel (e.g., of multiple channels or a group or set of channels). If the DSR MAC CE is not long enough to accommodate all DSRs, in one example, the UE device 105 includes the DSR for high-priority channel/set/group first (e.g., and does not transmit low priority DSRs due to the length limitation). In another example, however, the UE device 105 first includes the DSR of the channel having the largest amount of delayed data (as well as meeting both the delay timing threshold and the delay volume threshold).

In some cases, when a DSR transmission is triggered at the UE device 105, there may not be available uplink radio resources for the UE device 105 to transmit the DSR. In such cases, the UE device 105 may send a scheduling request to the network entity 112. In an example, the network entity 112 may allocate dedicated physical uplink control channel (PUCCH) resources for the UE device 105 to transmit such scheduling request. The PUCCH resource allocation may be configured at 210 by the message transmitted from the network entity 112 to the UE device 105.

In some cases, instead of (or in place of) the scheduling request (e.g., when there is no PUCCH resource allocation), the UE device 105 initiates a random access procedure. For example, the network entity 112 may allocate preambles or physical random access channel (PRACH) occasions for the UE device 105 to perform random access procedure for DSR transmission. A PRACH occasion includes a time-frequency resource for a UE device to transmit a preamble. In some cases, the preambles or PRACH occasions may be included in the message transmitted 210 from the network entity 112 to the UE device 105.

As shown, the network entity 112 next transmits 240 a resource allocation to the UE device 105 responsive to the DSR. For example, after receiving the DSR from the UE device 105 (as well as other UE devices), the network entity 112 may allocate resources to the UE (and other UEs) with a channel or a set/group of channels that has a higher-priority, because the DSR was triggered when the delayed data in the UE device 105 negatively impacts the XR capacity evaluation. When there are multiple UE devices of a common priority level, the network entity 112 may allocate resources to the UE device that has the greatest volume of delayed data. The resource allocation update may allow the UE device 105 to increase transmission bandwidth to shorten the time delays, reduce delayed data volume in the buffer, or both, resulting in a positive satisfaction level for the UE device 105.

FIG. 3 is a signaling diagram 300 depicting an example method of reporting delay status from the UE device 105 to the RAN 112, according to some embodiments. The signaling diagram 300 shares some common features with the signaling diagram 200 while including detailed features regarding various conditions that initiate the DSR generation and/or triggers the DSR transmission. As mentioned previously with reference to FIG. 2, different entities may replace the UE 105 or the RAN 112. As shown, the UE device 105 receives 310 from the RAN 112 a message that configures the UE device 105 for delay status reporting with one or more channels and delay thresholds associated therewith. See also 210 of FIG. 2. The UE device 105 determines 320 to transmit a DSR when a triggering condition is satisfied. Various triggering conditions are discussed below (e.g., 322-328, and 910-950 of FIG. 9).

Based on the received configuration for delay status reporting, the UE device 105 monitors 322 a first data arriving in at least one uplink buffer for the one or more channels. The one or more channels may include two or more channels sharing a common set of associated delay thresholds. In some cases, the status of the first data in the uplink buffer may be separate from other triggering conditions that may result in generating and transmitting the DSR (e.g., the monitoring 322 may be a selectable embodiment in dashed lines).

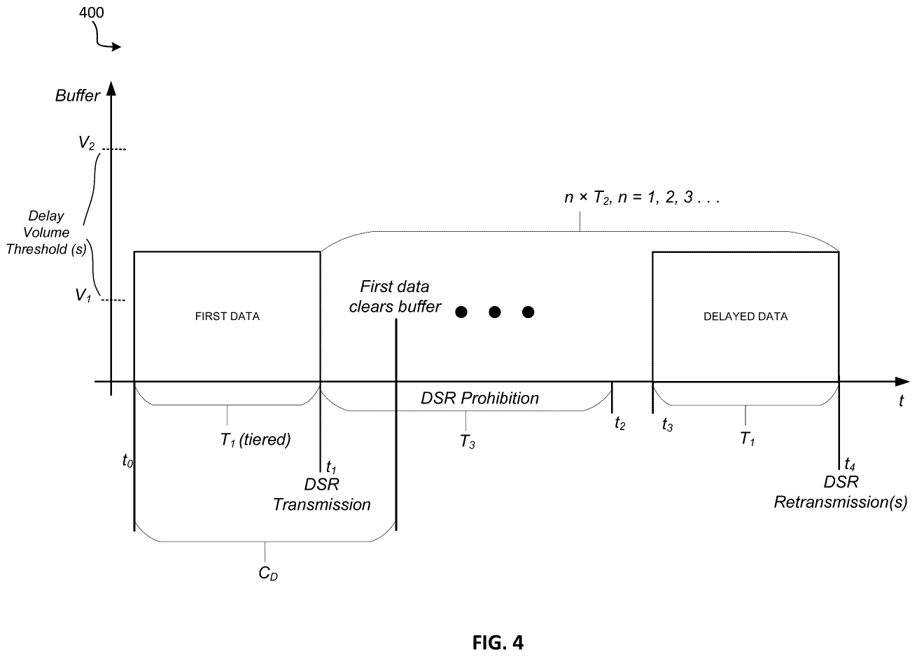

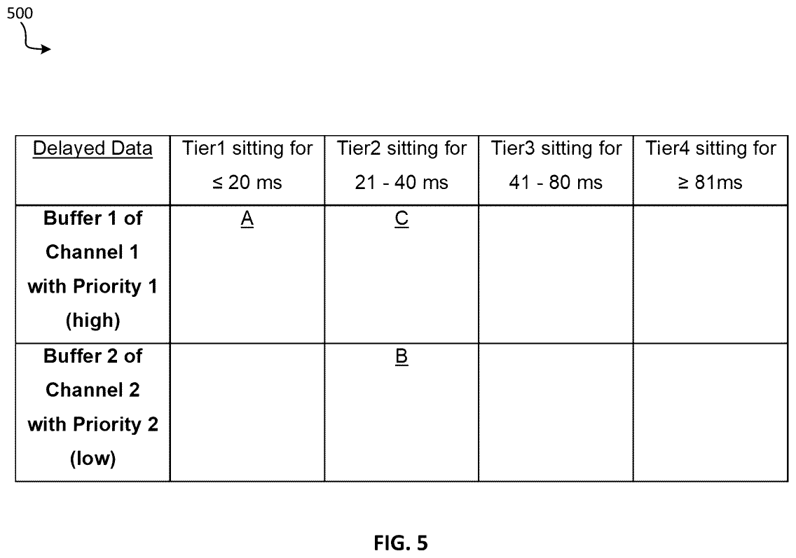

The UE device 105 determines 324 whether a delay of the first data in the buffer for the corresponding channel has reached a delay threshold received 310 earlier within the message. The delay threshold may include a delay timing threshold, a delay volume threshold, or both. A delay timing threshold may include a corresponding timing threshold for various timers. A delay volume threshold may include a configured volume limit configured for uplink buffer to trigger DSR transmissions (e.g., at 328 and further discussed in relation to FIGS. 4-5). When the delay of the first data has not reached 324 (NO branch) the delay threshold(s), the operation of the UE device 105 returns to the UE device monitoring 322 subsequent data arrivals.

On the other hand, when the delay has reached 324 (YES branch) the delay threshold(s), the operation of the UE device 105 proceeds to 326a-b and 328. As shown, the generation of the DSR at 326a or 326b may take place either before or after the determination 328 of triggering conditions satisfaction, depending on the implementation. Examples of various, non-exhaustive triggering conditions 910-950 are illustrated in FIG. 9 and are discussed below in combination with FIGS. 4 and 5, along with discussion of the delay thresholds. After DSR generation 326 and satisfying 328 trigger conditions, the UE device 105 transmits 330 the DSR to the RAN 112.

In FIG. 4, a graph 400 shows example delayed data volume in the uplink buffer (e.g., the y axis) of the UE device 105 along a timeline (e.g., the x axis). FIG. 4 shows three example timing periods T₁, T₂, and T₃ corresponding to three timer durations. The three example timing periods correspond to: (1) a duration T₁ in which specific data has been present in the uplink buffer, measured by a first timer; (2) a duration T₂ that specifies periodic transmission or re-transmission of subsequent DSRs after an initial DSR, measured by a second timer; and (3) a duration T₃ that prohibits the UE device 105 from transmitting a DSR, measured by a third timer. The delay timing threshold indicated by the message transmitted 310 from the RAN 112 may indicate a duration for at least one of the example timing periods T₁, T₂, and T₃ (e.g., the message need not indicate all three timer durations, which may otherwise be specified based on other parameters, calculations, or agreements).

For example, the delay timing threshold may indicate a value for at least T₁. As shown in FIG. 4, upon receiving the first data in the at least one uplink buffer at t₀, the UE device 105 starts the first timer. The first timer tracks at least a first tier of duration (T₁). The UE device 105 generates (e.g., at 326a or 326b of FIG. 3) the DSR upon the first timer reaching the duration threshold T₁ when the UE device 105 has not transmitted the first data. In other words, when the first timer expires at T₁, and when the first data in the uplink buffer of the corresponding channel is has a queueing delay greater than the delay timing threshold, the UE device 105 generates a DSR. See FIG. 9 element 920. Different T₁ tiers are discussed below in relation to FIG. 5.

In some cases, the configuration message defines or indicates triggering conditions based both on a volume threshold and a delay duration threshold. For example, a trigger condition can be satisfied when a volume of the data in the at least one uplink buffer is greater than a volume threshold defined with respect to at least one of the delay duration thresholds. For example, as shown in FIG. 4, the first data stays in the uplink buffer for a time period that exceeds the delay time threshold T₁ and the first data also exceeds the delay volume threshold V₁ (e.g., the lower indicator on the y axis in the graph 400). As such, the triggering conditions are satisfied and the UE device 105 transmits (e.g., at 330 of FIG. 3) the DSR at t₁ at the end of duration T₁.

In some cases, the delay volume threshold may include multiple tiers. In a different scenario, for example, if the delay volume threshold of the first data is configured to be V₂, (e.g., the upper indicator on the y axis in the graph 400) which is greater than the threshold volume V₁, the triggering conditions are not satisfied when timer T₁ expires, and the UE device 105 does not transmit the DSR at t₁. For example, as shown in FIG. 3, when the UE device 105 determines that the triggering condition has not been satisfied 328 (NO branch), the operation returns to the UE device monitoring 322 for subsequent data arrivals. The UE device 105 may cancel or clear the DSR associated with the first data when the first data clears the uplink buffer at t₂ after duration CD.

The UE device 105 may re-transmit a DSR or periodically transmit another DSR based on a second timer monitoring the periodicity T₂. As shown in FIG. 4, the UE device 105 may re-transmit a DSR at t₄ when both the second timer (tracking an integer number of cycles of T₂) and the first timer (e.g., T₁ of delayed data in the uplink buffer) expire. See FIG. 9 element 910. The UE device 105 may stop the second timer in various situations. For example, after the UE device 105 does not have delayed data in the uplink buffer, the UE device 105 stops the second timer. In some embodiments, the UE device 105 stops the second timer when the amount of delayed data has become smaller than a delay volume threshold. In some embodiments, the UE device 105 stops the second timer when the MAC entity resets. In some embodiments, the UE device 105 stops the second timer when the UE device 105 receives a command, from the RAN 112, requesting the UE to stop second timer (not shown). For example, the command may be a MAC CE with a unique logical channel to distinguish itself from other MAC CEs. In some cases, the UE device 105 may start or re-start the second timer after transmitting a present or most-recently-generated DSR. The first message includes a periodicity that is used to set up the time length of the second timer.

The retransmission of a DSR may occur periodically for every complete cycle of T₂ if delayed data (pre-existing or new) continue to experience delays in the uplink buffer exceeding T₁ and the retransmission is not prohibited by the third timer. The third timer measures a duration in which the UE device 105 shall not re-transmit a subsequent DSR even if triggering conditions are satisfied after a previous DSR has been transmitted. For example, after the UE device 105 transmits a DSR at t₁, the UE device 105 starts a third timer and may not transmit another DSR until after t₂. The third timer prevents frequent transmission of DSRs that may overburden communication overhead. In some embodiments, the message transmitted 310 from the RAN 112 to the UE device 105 configures the duration T₃ of the third timer. In some embodiments, regardless of the configuration of the third timer, the UE device 105 may not transmit another (or a) DSR immediately following a most recent DSR transmission when the UE device receives a new uplink grant from the RAN 112.

Another example of triggering conditions includes the UE device 105 monitoring new data arrival in the configured one or more channels when there are delayed data in the uplink buffer. For example, the transmission of the DSR may be triggered when new data arrives in the uplink buffer and the UE device 105 has delayed data in the uplink buffer. In some embodiments, the trigging conditions includes detecting new data arrivals when an amount of delayed data in the uplink buffer is larger than the delay volume threshold.

In some cases, as shown in FIG. 9 at element 930, the triggering conditions are determined by the amount of delayed data. For example, when the total amount of delayed data in the UE device 105 is greater than a threshold, the UE device 105 transmits the DSR. The total amount of delayed data may consider all channels as a whole instead of individual channel/set/group.

In some cases, as shown in FIG. 9 at element 940, the triggering conditions are in response to signaling from the RAN 112. For example, when the UE device 105 receives a command from the RAN 112 asking for a DSR, the UE device 105 may transmit the DSR. If the UE device 105 has not generated a DSR, the UE device 105 may transmit a notification to the RAN 112 stating the same, and/or transmit a subsequent DSR to be generated when delay thresholds are met.

In some embodiments, the command is communicated in a MAC CE. In some embodiments, the command includes the ID of a channel/set/group so that the UE device reports the delay status of the specific channel/set/group. In some embodiments, the command includes a delay threshold. The delay threshold may supplement, update, or replace the delay thresholds configured by the message at 310. The delay thresholds of the command may indicate delay time thresholds and/or delay volume thresholds. The UE device 105 may correspondingly generate DSRs when delayed data exceed the specified thresholds in the uplink buffer.

In some embodiments, as shown in FIG. 9 at element 950, the triggering conditions are associated with other uplink transmissions, such as a buffer status report. For example, when the UE device 105 triggers a buffer status report, the buffer status report trigger automatically triggers a DSR transmission and the UE device 105 correspondingly generates a DSR transmission. On the other hand, the UE device 105 may be configured to correlate the buffer status report to the DSR.

For example, if the UE device 105 triggers a DSR, then the UE device 105 also generates a buffer status report. Both the DSR and buffer status report may facilitate the RAN 112 to monitor the uplink buffer status of multiple UE devices in order to schedule radio resources to improve wireless capacity, which might greatly benefit XR applications.

As discussed above, several factors may impact the triggering conditions: (1) how long data have been delayed (as measured by the first timer); (2) timed reporting behaviors to ensure timely reporting as well as to prevent unnecessary reporting (e.g., the second and the third timers); (3) how much data have been delayed in the uplink buffer (as measured in terms of volume); and (4) the priority of the channel of the uplink buffer (e.g., not all UE devices or channels are treated equal). Tiers of durations and the channel priorities are further discussed in relation to FIG. 5 below.

FIG. 5 illustrates example events 500 associated with delayed data for reporting delay status. The tier of the first timer may include a series of sectional durations. As shown, on the top row, four example tiers of durations of T₁ are provided. The four example tiers for T₁ include: (1) within 20 ms; (2) between 21 and 40 ms; (3) between 41 and 80 ms; and (4) 81 ms or more. In some cases, the tier information may be provided in the DSR so that the RAN 112 can determine resource allocation and/or channel prioritization. In some embodiments, the series of sectional durations includes an incremental increase in lengths, such as 0 -10 ms, 11-30 ms, 31-60 ms, and above 61 ms. Note that, although this example uses ms duration units, alternative measurement units may be used.

Two priority levels for uplink buffers corresponding to two channels are illustrated in FIG. 5. As shown, the priority levels are provided for Buffer 1 of Channel 1 and Buffer 2 of Channel 2. Priority 1 of Channel 1 is higher than Priority 2 of Channel 2. Three examples of delayed data (A, B, and C) are illustrated. The delayed data have different delay properties in terms of delay duration and channel priority levels.

In some embodiments, the triggering conditions associated with the DSR specify that the channel(s) configured by the RAN 112 for DSR have a higher priority than other channels. As shown in FIG. 5, when the delayed data B and C are both in the tier 2, because the delayed data C has a higher priority level than the delayed data B, the UE device 105 transmits the DSR associated with the delayed data C while not transmitting the DSR associated with the delayed data B.

Similarly, the triggering conditions are satisfied when the first timer expires and the first channel has the highest priority among the channels with data or delayed data in the uplink buffer.

In some embodiments, the triggering conditions include advancing the tier duration of the first timer. For example, the delayed data A may not have reached the delay volume threshold, and the triggering conditions for DSR transmission is not satisfied. As such, when delayed data A is in tier 1 (e.g., within 20 ms), the UE device 105 does not transmit the DSR (even though the first timer has expired at the first tier). When the time delay of the delayed data extends into the next tier or another specified tier (e.g., the third or the fourth tier), the UE device 105 may transmit the DSR.

For low priority channels, the triggering conditions may include exceeding both the delay volume threshold and a highest tier (e.g., tier 4 of FIG. 5) of the first timer. For example, the UE device 105 may only transmit a DSR corresponding to delayed data B upon reaching tier 4.

In some embodiments, the UE combines delayed data within a tier to meet the delayed volume threshold for triggering the DSR transmission. For example, suppose each of the delayed data A and the delayed data C has a volume lower than the delay volume threshold for the channel in the uplink buffer, the UE device 105 may not trigger the corresponding DSR. When the delayed data A stays in the uplink buffer for a duration extending into tier 2 (while the delayed data C stays in tier 2), the combined size of the delayed data A and C is larger than the delay volume threshold. As such, the UE device 105 transmits the DSR generated while in tier 1 with respect to the delayed data A when it reaches tier 2 (and may or may not include the information of delayed data C in tier 2). In this manner, the variables of delay tier, delay volume, and channel priority may all interact. Using these parameters, a network 112 may request DSRs at a frequency helpful for improving system capacity while limiting the overhead used to transmit DSRs.

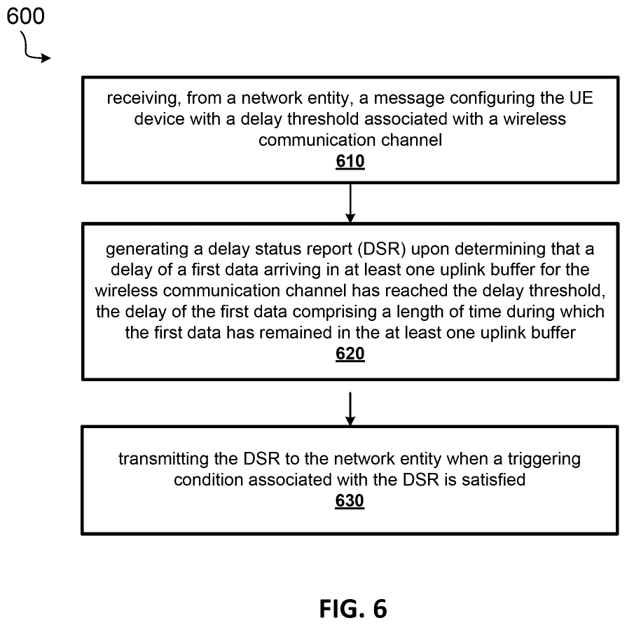

FIG. 6 is a flow diagram depicting a method 600 for reporting delay status by a UE device, according to some embodiments. Method 600 is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method 600 is performed by a UE device, such as the UE device 105 of FIGS. 1, 2, or 3.

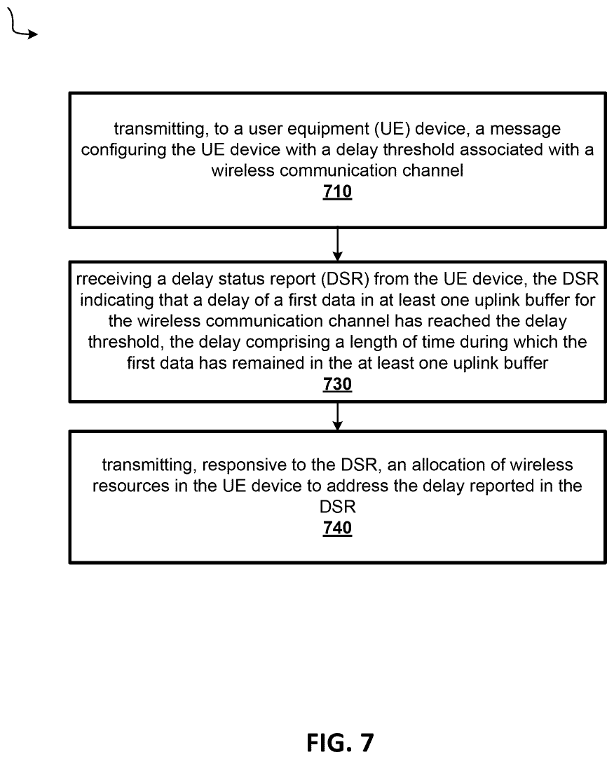

With reference to FIGS. 6 and 7, the methods 600, 700 illustrate example functions used by various embodiments. Although specific function blocks (“blocks”) are disclosed in methods 600, 700, such blocks are examples. That is, embodiments are well suited to performing various other blocks or variations of the blocks recited in methods 600, 700. The blocks in method 600, 700 may be performed in an order different than presented, and that not all of the blocks in method 600, 700 must be performed.

As shown in FIG. 6, the method 600 includes the block 610 of receiving, from a network entity, a message configuring the UE device with a delay threshold associated with a wireless communication channel (e.g., operation 210 of FIG. 2) for delay status reporting. The method 600 includes the block 620 of generating a delay status report (DSR) upon determining that a delay of a first data arriving in at least one uplink buffer for the wireless communication channel has reached the delay threshold (e.g., operation 220 of FIG. 2). The delay of the first data comprising a length of time during which the first data has remained in the at least one uplink buffer. The method 600 includes the block 630 of transmitting the DSR to the network entity when a triggering condition associated with the DSR is satisfied (e.g., operation 230 of FIG. 2).

In aspects, the one or more channels may include two or more channels sharing a common set of associated delay thresholds. The delay thresholds may include at least one of a delay timing threshold or a delay volume threshold.

In aspects, the message configuring the UE device may include at least one of: a radio resource control (RRC) reconfiguration message; an RRC setup message; an RRC re-establishment message; an RRC resume message; or a system information message.

In aspects, generating the DSR is based on a first timer. The UE device may start the first timer T₁ upon receiving the first data in the at least one uplink buffer for the one or more channels. See FIG. 4 at time t₀. The first timer may track at least a first tier of duration. The UE device may generate the DSR upon the first timer reaching the first tier of duration and when the UE device has not transmitted the first data. In some cases, the first tier of duration is one of multiple tiers of durations. See FIG. 5 columns. The multiple tiers of durations may include a series of sectional durations, which may include an incremental increase in lengths. In aspects, the UE device may stop the first timer when the UE device has completed transmitting the first data.

The triggering condition associated with the DSR may include an expiration of the first timer T₁ before the UE device has completed transmitting the first data. In some cases, the triggering condition associated with the DSR may further include the one or more channels configured by the network entity have a higher priority than other channels. See FIG. 5 rows. In some cases, the triggering condition associated with the DSR may further include a volume of the first data in the at least one uplink buffer is greater than a volume threshold V₁ defined in the at least one of the delay thresholds.

In aspects, the UE device may start a second timer T₂ upon transmitting the DSR to the network entity. The UE device may generate and transmit a second DSR upon an expiration of the second timer. In some embodiments, the UE device stops the second timer when the UE device has cleared data exceeding the at least one of the delay thresholds in the at least one uplink buffer. In some embodiments, the UE device stops the second timer when a volume of data exceeding the at least one of the delay thresholds in the at least one uplink buffer has become smaller than a volume threshold V₁ defined in the at least one of the delay thresholds. In some embodiments, the UE device stops the second timer when resetting a MAC entity. In some embodiments, the UE device stops the second timer when the UE device receives, from the network entity, a request to stop the second timer. The first timer and the second timer may be configured by the message received 210, 310 from the network entity 112 of FIG. 2 or 3.

In aspects, the UE device may start a third timer T₃ upon transmitting the DSR and refrain from transmitting a next DSR until the third timer has expired (see FIG. 4), wherein the third timer and the first timer are configured by the message configuring the UE device. In some cases, the triggering condition associated with the next DSR may include an expiration of the third timer.

In aspects, the triggering condition associated with the DSR may include receiving new data arriving in the at least one uplink buffer for the one or more channels. The delay of the first data may further include an amount of delayed data greater than a delay volume threshold. The triggering condition associated with the DSR may include receiving a command from the network entity and generating and transmitting the DSR responsive to receiving the command. The command may include one or more of a MAC CE, an ID of a channel for which the DSR is generated, a delay timing threshold, or a delay volume threshold.

In aspects, the triggering condition associated with the DSR may incorporate generating a buffer status report. Transmitting the DSR to the network entity may include transmitting both the buffer status report and the DSR to the network entity.

In aspects, the DSR may include at least one of: one or more identifiers (IDs) for the one or more channels; buffer size information for the first data in the at least one uplink buffer; a target level of resource allocation satisfaction for extended reality (XR) communications; or a maximal level of delay permissible in the UE based on a memory buffer size or a delay threshold. The delay threshold may include at least one of: a tier of delay time or a tier of delay volume.

In aspects, transmitting the DSR to the network entity may include transmitting a MAC CE or transmitting a physical layer signaling of the DSR. The MAC CE may include an ID associated with the DSR. The MAC CE may further include a buffer status indicating respective amounts for both delayed and non-delayed data. The MAC CE may include a plurality of DSRs corresponding to a plurality channels of the one or more channels. The MAC CE may prioritize the plurality of DSRs based on a priority ranking of the plurality channels. In some embodiments, the priority ranking includes two or more layers of rankings. The two or more layers of rankings may include at least: a first layer of ranking based on priority categories and a second layer of ranking based on a respective volume of delayed data.

In aspects, the UE device may receive a new uplink grant from the network entity and cancel, upon having transmitted the DSR to the network entity previously, a subsequent DSR. In aspects, the UE device may clear the first data C_{D} in the at least one uplink buffer upon the UE device having completed transmitting the first data at t₂. See FIG. 4.

The UE device may receive, from the network entity in response to receiving the DSR, allocation of additional resources, indications to adjust transmission priorities, or both. The allocation of additional resources may reduce the data delay status of the UE device.

FIG. 7 is a flow diagram depicting a method for resource allocation by a network entity, according to some embodiments. Method 700 is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method 700 is performed by a network entity, such as the network entity 112 of FIGS. 1, 2, or 3.

As shown in FIG. 7, the method 700 includes the block 710 of transmitting, from the network entity to a user equipment (UE) device, a message configuring the UE device with a delay threshold associated with a wireless communication channel. See also 210, 310, 610. The method 700 includes the block of 730 of receiving a DSR from the UE device. The DSR indicates that a delay of a first data in at least one uplink buffer for the wireless communication channel has reached the delay threshold. The delay includes a length of time during which the first data has remained in the at least one uplink buffer. The method 700 includes the block 740 of transmitting, responsive to the DSR, an allocation of wireless resources in the UE device to address the delay reported in the DSR. See also 240 of FIG. 2.

In aspects, the network entity may receive a plurality of DSRs from a plurality of UE devices. The network entity may allocate wireless resources to respective UE devices based on respective priorities, delays, or both. In some embodiments, the network entity transmits the message configuring the UE device by transmitting a MAC CE indicating a traffic priority (e.g., priority of one or more channels). The network entity may allocate the additional wireless resources in the UE device based on the traffic priority. In some embodiments, the network entity transmits to the UE device (1) allocation of additional resources, (2) indications to adjust transmission priorities, or (3) both. In some embodiments, the message configuring the UE device includes at least one of: an RRC reconfiguration message; an RRC setup message; an RRC re-establishment message; an RRC resume message; or a system information message.

FIG. 8 is a block diagram depicting an example device diagram 800 of a UE device 805 (e.g., UE device 105), according to some embodiments. The device diagram 800 describes a UE device that can implement various aspects of reporting delay status (e.g., in XR applications). The UE device 805 may include additional functions and interfaces that are omitted from FIG. 8 for the sake of clarity. The UE device 805 includes antennas 801, a radio frequency (RF) front end 804, and one or more RF transceivers 806 (e.g., a 3GPP Fourth Generation (4G) Long Term Evolution (LTE) transceiver 806-1 and a 5G NR transceiver 806-2) for communicating with a base station 112 in a RAN 112 in FIG. 1, such as a 5G RAN and/or an E-UTRAN. One antenna array may be used for cellular signaling and (optionally) another antenna array may be used for wireless communication across a sidelink connection. The UE device 805 may include one or more additional transceivers 806-3, such as a local wireless network transceiver, for communicating over one or more local wireless networks (e.g., WLAN, Bluetooth, Near-Field Communication (NFC), a personal area network (PAN), Wireless Fidelity Direct (Wi-Fi-Direct), IEEE 802.15.4, ZigBee, Thread, and the like) with other UE devices (not shown), such as those in a wirelessly tethered configuration with the UE device 805. The RF front end 804 couples or connects the LTE transceiver 806-1, the 5G NR transceiver 806-2, and the local wireless network transceiver 806-3 to the antennas 801 to facilitate various types of wireless communication.

The antennas 801 of the UE device 805 include an array of multiple antennas configured similar to or different from each other. The antennas 801 and the RF front end 804 are tuned to, and/or can be tunable to, one or more frequency bands, such as those defined by the 3GPP LTE, 3GPP 5G NR, IEEE WMAN, or other communication standards. The antennas 801, the RF front end 804, the LTE transceiver 806-1, the 5G NR transceiver 806-2, and/or the local wireless network transceiver 806-3 are configured to support beamforming (e.g., analog, digital, or hybrid), or in-phase and quadrature (I/Q) operations (e.g., I/Q modulation or demodulation operations) for the transmission and reception of communications with the base station 112. By way of example, the antennas 801 and the RF front end 804 operate in sub-gigahertz bands, sub-6 GHz bands, and/or above 6 GHz bands defined by the 3GPP LTE, 3GPP 5G NR, or other communication standards.

Using at least a portion of the antennas 801, the UE device 805 can form beams that are steered or un-steered, wide or narrow, or shaped (e.g., as a hemisphere, cube, fan, cone, or cylinder). The one or more transmitting antennas may produce an un-steered omnidirectional radiation pattern or a steerable beam.

The UE device 805 includes one or more sensors 808 implemented to detect various properties such as temperature, supplied power, power usage, battery state, or the like. The sensors 808 can include any one or a combination of temperature sensors, thermistors, battery sensors, and power usage sensors. The UE device 805 uses the various properties to determine whether the UE device 805 has the capability to connect to the cellular network 112 over its air interface, or if the UE device 805 only has enough resources (e.g., battery power, etc.) to connect to the cellular network 112 using a sidelink connection to another UE device.

The UE device 805 also includes at least one processor 810 and a non-transitory computer-readable storage media 812 (CRM 812). The computer-readable storage media described herein excludes propagating signals. The CRM 812 includes any suitable memory or storage device such as random-access memory (RAM), static RAM (SRAM), dynamic RAM (DRAM), non-volatile RAM (NVRAM), read-only memory (ROM), or Flash memory useable to store device data 814 of the UE device 805. The device data 814 includes, for example, user data, multimedia data, beamforming codebooks, applications, and/or an operating system of the UE device 805, which are executable by the processor 810 to enable user-plane communication, control-plane signaling, and user interaction with the UE device 805.

The CRM 812 includes a communication manager 816. Alternatively, or additionally, the communication manager 816 is implemented in whole or part as hardware logic or circuitry integrated with or separate from other components of the UE device 805. The communication manager 816 configures the RF front end 804, the LTE transceiver 806-1, the 5G NR transceiver 806-2, and/or the local wireless network transceiver 806-3 to perform one or more wireless communication operations.

The CRM 812 further includes a DSR manager 818, a DSR configuration client 820, and one or more uplink buffers 822. The DSR manager 818 and the DSR configuration client 820 allow the UE device 805 to be configured by a network entity to generate and transmit DSRs regarding delayed data in the one or more uplink buffers 822. In some embodiments, one or more of these components are implemented in whole or part as hardware logic or circuitry integrated with or separate from other components of the UE device 805.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

### EXAMPLE ASPECTS

Example 1 is a method of wireless communications by a user equipment (UE) device, the method comprising:
receiving, from a network entity, a message configuring the UE device with a delay threshold associated with a wireless communication channel;
generating a delay status report (DSR) upon determining that a delay of a first data arriving in at least one uplink buffer for the wireless communication channel has reached the delay threshold, the delay of the first data comprising a length of time during which the first data has remained in the at least one uplink buffer; and
transmitting the DSR to the network entity when a triggering condition associated with the DSR is satisfied.

Example 2 is a method according to example 1, wherein the wireless communication channel comprises two or more channels sharing a common set of associated delay thresholds, and wherein the delay threshold comprises at least one of a delay timing threshold or a delay volume threshold.

Example 3 is a method according to any one of examples 1 or 2, wherein the message configuring the UE device comprises at least one of:
a radio resource control (RRC) reconfiguration message;
an RRC setup message;
an RRC re-establishment message;
an RRC resume message; or
a system information message.

Example 4 is a method according to any one of examples 1 to 3, wherein the generating the DSR comprises:
starting a first timer upon receiving the first data in the at least one uplink buffer for the wireless communication channel, wherein the first timer tracks at least a first tier of duration; and
generating the DSR upon the first timer reaching the first tier of duration and when the UE device has not completed transmitting the first data.

Example 5 is a method according to example 4, wherein the first tier of duration is one of a plurality tiers of durations.

Example 6 is a method according to example 5, wherein the plurality tiers of durations comprise a series of sectional durations having an incremental increase in lengths.

Example 7 is a method according to example 4, further comprising:
stopping the first timer when the UE device removes the first data from the at least one uplink buffer.

Example 8 is a method according to example 4, wherein the triggering condition associated with the DSR comprises:
an expiration of the first timer before the UE device has completed transmitting the first data.

Example 9 is a method according to example 8, wherein the triggering condition associated with the DSR further comprises at least one of:
the wireless communication channel configured by the network entity has a higher priority than other channels; or
a volume of the first data in the at least one uplink buffer is greater than a volume threshold defined in the delay threshold.

Example 10 is a method according to example 4, further comprising:
starting a second timer upon transmitting the DSR to the network entity;
generating and transmitting a second DSR upon an expiration of the second timer; and
stopping the second timer when:
   the UE device has cleared data in the at least one uplink buffer exceeding the delay threshold;
   a volume of data in the at least one uplink buffer has become smaller than a volume threshold defined in the delay threshold;
   resetting a media access control (MAC); or
   receiving, from the network entity, a request to stop the second timer.

Example 11 is a method according to example 10, wherein the first timer and the second timer are configured by the message received from the network entity.

Example 12 is a method according to example 4, further comprising:
starting a third timer upon transmitting the DSR; and
refraining from transmitting a next DSR until the third timer has expired, wherein the third timer and the first timer are configured by the message configuring the UE device.

Example 13 is a method according to example 12, wherein the triggering condition associated with the next DSR comprises an expiration of the third timer.

Example 14 is a method according to example 1, wherein the triggering condition associated with the DSR comprises:
receiving new data arriving in the at least one uplink buffer for the wireless communication channel, wherein the delay of the first data further comprises an amount of delayed data greater than a delay volume threshold.

Example 15 is a method according to example 1, wherein the triggering condition associated with the DSR comprises:
receiving a command from the network entity; and
generating and transmitting the DSR responsive to receiving the command, wherein the command comprises at least one of:
   a media access control (MAC) control element (MAC CE);
   an identifier (ID) of a channel for which the DSR is generated;
   a delay timing threshold; or
   a delay volume threshold.

Example 16 is a method according to example 1, wherein the triggering condition associated with the DSR comprises: generating a buffer status report.

Example 17 is a method according to example 16, wherein transmitting the DSR to the network entity comprises:
transmitting both the buffer status report and the DSR to the network entity.

Example 18 is a method according to any one of examples 1-13, wherein the DSR comprises at least one of:
one or more identifiers (IDs) for the one or more channels;
buffer size information for the first data in the at least one uplink buffer;
a target level of resource allocation satisfaction for extended reality (XR) communications; or
a maximal level of delay permissible in the UE based on a memory buffer size or at least one of:
   a tier of delay time, or
   a tier of delay volume.

Example 19 is a method according to any one of examples 1-18, wherein transmitting the DSR to the network entity comprises:
transmitting a media access control control element (MAC CE), wherein the MAC CE comprises an identifier (ID) associated with the DSR; or
transmitting a physical layer signaling of the DSR.

Example 20 is a method according to example 19, wherein the MAC CE further comprises a buffer status indicating respective amounts for both delayed and non-delayed data.

Example 21 is a method according to example 19, wherein the MAC CE comprises a plurality of DSRs corresponding to a plurality of wireless communication channels, and wherein the MAC CE prioritizes the plurality of DSRs based on a priority ranking of the plurality of wireless communication channels.

Example 22 is a method according to example 21, wherein the priority ranking comprises two or more layers of rankings, the two or more layers of rankings comprising at least:
a first layer of ranking based on priority categories; and
a second layer of ranking based on a respective volume of delayed data.

Example 23 is a method according to any one of examples 1-22, further comprising:
receiving a new uplink grant from the network entity; and
canceling, upon having transmitted the DSR to the network entity previously, a subsequent DSR.

Example 24 is a method according to any one of examples 1-23, further comprising:
receiving, from the network entity, allocation of additional resources, indications to adjust transmission priorities, or both.

Example 25 is a method according to any one of examples 1-24, further comprising clearing the first data in the at least one uplink buffer upon the UE device having completed transmitting the first data.

Example 26 is a method of wireless communications by a network entity, the method comprising:
transmitting, to a user equipment (UE) device, a message configuring the UE device with a delay threshold associated with a wireless communication channel;
receiving a delay status report (DSR) from the UE device, the DSR indicating that a delay of a first data in at least one uplink buffer for the wireless communication channel has reached the delay threshold, the delay comprising a length of time during which the first data has remained in the at least one uplink buffer; and
transmitting, responsive to the DSR, an allocation of wireless resources in the UE device to address the delay reported in the DSR.

Example 27 is a method according to example 26, further comprising:
receiving a plurality of DSRs from a plurality of UE devices; and
allocating wireless resources to respective UE devices based on respective priorities, delays, or both.

Example 28 is a method according to example 26, wherein transmitting the message configuring the UE device comprises transmitting a media access control control element (MAC CE) indicating a traffic priority; and
wherein the allocation of wireless resources in the UE device is based on the traffic priority.

Example 29 is a method according to example 28, wherein the transmitting the allocation of wireless resources to the UE comprises:
(1) an allocation of additional resources, (2) indications to adjust transmission priorities, or (3) both.

Example 30 is a method according to example 26, wherein the message configuring the UE device comprises at least one of:
a radio resource control (RRC) reconfiguration message;
an RRC setup message;
an RRC re-establishment message;
an RRC resume message; or
a system information message.

Example 31 is a method according to example 26, wherein the DSR comprises at least one of:
an identifier (ID) for the wireless communication channel;
buffer size information for the first data in the at least one uplink buffer;
a target level of resource allocation satisfaction for extended reality (XR) communications; or
a maximal level of delay permissible in the UE based on a memory buffer size or at least one of:
   a range of delay time, or
   a range of delay volume.

Example 32 is a user equipment (UE), comprising:
one or more radio frequency (RF) modems;
a processor coupled to the one or more RF modems; and
at least one memory storing executable instructions, the executable instructions to manipulate at least one of the processor or the one or more RF modems to perform the method of any of examples 1-25.

Example 33 is a network entity comprising:
one or more radio frequency (RF) modems;
a processor coupled to the one or more RF modems; and
at least one memory storing executable instructions, the executable instructions to manipulate at least one of the processor or the one or more RF modems to perform the method of any of examples 26-31.

1-17. (canceled)

18. A method of wireless communications by a user equipment (UE), the method comprising:
receiving, from a network entity, a message configuring the UE with a delay threshold associated with a first channel;
generating a delay status report (DSR) based on a delay of a first data in an uplink buffer for the first channel having reached the delay threshold; and
transmitting the DSR to the network entity based on satisfying a triggering condition associated with the DSR.

19. The method of claim 18, wherein:
the delay of the first data comprises a length of time during which the first data has remained in the uplink buffer; and
the first channel comprises a group of channels associated with the delay threshold, and wherein the delay threshold comprises a delay timing threshold.

20. The method of claim 18, wherein the message configuring the UE comprises at least one of:
a radio resource control (RRC) reconfiguration message;
an RRC setup message;
an RRC re-establishment message;
an RRC resume message; or
a system information message.

21. The method of claim 18, wherein the generating the DSR comprises:
starting a first timer upon receiving the first data in the uplink buffer for the first channel, wherein the first timer tracks at least a first tier of duration; and
generating the DSR upon the first timer reaching the first tier of duration and when the UE has not completed transmitting the first data.

22. The method of claim 21, wherein the triggering condition associated with the DSR comprises:
an expiration of the first timer before the UE has completed transmitting the first data.

23. The method of claim 21, further comprising at least one of:
starting a second timer upon transmitting the DSR to the network entity;
generating and transmitting a second DSR upon an expiration of the second timer; and
stopping the second timer when:
the UE has cleared data in the uplink buffer exceeding the delay threshold;
resetting a media access control (MAC); or
receiving, from the network entity, a request to stop the second timer.

24. The method of claim 18, wherein the triggering condition associated with the DSR comprises at least one of:
receiving new data in the uplink buffer for the first channel; or
receiving a command from the network entity, and generating and transmitting the DSR responsive to receiving the command, wherein the command comprises at least one of:
a media access control (MAC) control element (MAC CE);
an identifier (ID) of a channel for which the DSR is generated; or
a delay timing threshold.

25. The method of claim 18, wherein the DSR comprises at least one of:
one or more identifiers (IDs) for the one or more channels;
buffer size information for the first data in the uplink buffer;
a target level of resource allocation satisfaction for extended reality (XR) communications; or
a maximal level of delay permissible in the UE based on a memory buffer size or a tier of delay time.

26. The method of claim 18, wherein transmitting the DSR to the network entity comprises:
transmitting a media access control control element (MAC CE), wherein the MAC CE comprises an identifier (ID) associated with the DSR, wherein the MAC CE associated with the DSR has a higher priority than data from other logical channels.

27. A method of wireless communications by a network entity, the method comprising:
transmitting, to a user equipment (UE), a message configuring the UE with a delay threshold associated with a first channel;
receiving a delay status report (DSR) from the UE, the DSR indicating that a delay of a first data in an uplink buffer for the first channel has reached the delay threshold; and
transmitting, responsive to the DSR, an allocation of wireless resources for the UE to address the delay reported in the DSR.

28. The method of claim 27, wherein:
the delay comprises a length of time during which the first data has remained in the uplink buffer; and
the first channel comprises a group of channels associated with the delay threshold, and wherein the delay threshold comprises a delay timing threshold.

29. The method of claim 27, wherein the message configuring the UE comprises at least one of:
a radio resource control (RRC) reconfiguration message;
an RRC setup message;
an RRC re-establishment message;
an RRC resume message; or
a system information message.

30. The method of claim 27, wherein receiving the DSR from the UE comprises:
receiving a media access control control element (MAC CE), wherein the MAC CE comprises an identifier (ID) associated with the DSR, wherein the MAC CE has a higher priority than data from other logical channels.

31. An apparatus of a user equipment (UE) for wireless communication, the apparatus comprising:
one or more radio frequency (RF) modems;
a processor coupled to the one or more RF modems; and
at least one memory storing executable instructions, the executable instructions to manipulate at least one of the processor or the one or more RF modems to:
receive, from a network entity, a message configuring the UE with a delay threshold associated with a first channel;
generate a delay status report (DSR) upon determining that a delay of a first data in an uplink buffer for the first channel has reached the delay threshold; and
transmit the DSR to the network entity based on satisfying a triggering condition associated with the DSR.

32. The apparatus of claim 31, wherein:
the delay of the first data comprises a length of time during which the first data has remained in the uplink buffer; and
the first channel comprises a group of channels associated delay thresholds, and wherein the delay threshold comprises a delay timing threshold.

33. The apparatus of claim 31, wherein the executable instructions further manipulate the at least one of the processor or the one or more RF modems to:
transmit, to the network entity, a scheduling request when additional uplink radio resources are to be allocated for transmitting the DSR.

34. The apparatus of claim 31, wherein the DSR comprises at least one of:
one or more identifiers, IDs, for the one or more channels; or
buffer size information for the first data in the uplink buffer.

35. The apparatus of claim 31, wherein the executable instructions further manipulate the at least one of the processor or the one or more RF modems to:
start a first timer upon receiving the first data in the uplink buffer for the first channel, wherein the first timer tracks at least a first tier of duration; and
generate the DSR upon the first timer reaching the first tier of duration and when the UE has not completed transmitting the first data.

36. The apparatus of claim 35, wherein the triggering condition associated with the DSR comprises:
an expiration of the first timer before the UE has completed transmitting the first data.

37. The apparatus of claim 31, wherein the executable instructions further manipulate the at least one of the processor or the one or more RF modems to:
transmit a media access control control element (MAC CE), wherein the MAC CE comprises an identifier (ID) associated with the DSR, wherein the MAC CE associated with the DSR has a higher priority than data from other logical channels.
